(19) United States
(12) Patent Application Publication
(10) Pub. No.: US 2024/0004990 A1
(43) Pub. Date: Jan. 4, 2024

(54) TECHNIQUES TO ENABLE CO-EXISTENCE AND INTER-OPERATION OF LEGACY DEVICES AND TEE-IO CAPABLE DEVICES FROM CONFIDENTIAL VIRTUAL MACHINES

(71) Applicant: Intel Corporation, Santa Clara, CA (US)

(72) Inventor: Utkarsh Y. Kakaiya, Folsom, CA (US)

(73) Assignee: Intel Corporation, Santa Clara, CA (US)

(21) Appl. No.: 17/854,159

(22) Filed: Jun. 30, 2022

(51) Int. Cl. G06F 21/53; G06F 9/455

(52) U.S. Cl. CPC G06F 21/53; G06F 9/45558; G06F 2009/45579; G06F 2009/45587; G06F 2221/034

(57) ABSTRACT

Methods and apparatus relating to techniques to enable co-existence and inter-operation of legacy devices and Trusted Execution Environment (TEE) Input/Output (TO) capable devices from confidential virtual machines are described. In an embodiment, a processor executes at least one Trusted Environment (TE) with a TE address space and a non-TE address space. Logic circuitry selects between the TE address space and the non-TE address space based at least in part on a value of a TE tag for a transaction. The TE address space maps one or more TE Input/Output (TO) devices and the non-TE address space maps one or more legacy IO devices. Other embodiments are also disclosed and claimed.

### FIELD

The present disclosure generally relates to the field of processors. More particularly, some embodiments relate to techniques to enable co-existence and inter-operation of legacy devices and Trusted Execution Environment (TEE) Input/Output (IO) capable devices from confidential virtual machines.

### BACKGROUND

Some processors support a Trusted Execution Environment (TEE) to ensure that code and data loaded in a secured TEE compute or storage device is protected for confidentiality and integrity. Generally, “confidentiality” can be provided by memory encryption to protect code and/or data. Moreover, “data integrity” aims to prevent unauthorized entities from altering TEE data when an entity outside the TEE processes data and “code integrity” ensures that any code associated with the TEE is not replaced or modified by unauthorized entities.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of a high-level architecture for a Trusted Execution Environment (TEE) Input/Output (TEE-IO) framework, which may be utilized in some embodiments.

FIG. 2 illustrates high-level architectures for processing of Memory Mapped Input/Output (MMIO) and Direct Memory Access (DMA) transactions for the TEE-IO architecture of FIG. 1.

FIG. 3A illustrates a block diagram of an architecture to generate TEE tags for MMIO transactions from TEE Virtual Machines (TVMs), according to an embodiment.

FIG. 3B illustrates a block diagram of an architecture to generate a TEE tag for DMA transactions initiated from the device interfaces assigned to TVMs, according to an embodiment.

FIG. 3C illustrates a block diagram of an architecture to generate a TEE tag for Peer-to-Peer (P2P) transactions initiated from the device interfaces assigned to TVMs, according to an embodiment.

FIG. 4A illustrates a block diagram of an architecture with multiple TEE Polarity Merger & Trackers (TPMTs), according to some embodiments.

FIG. 4B illustrates a flow diagram of a method 450 to enable co-existence and inter-operation of legacy devices and TEE-IO capable devices, according to an embodiment.

FIG. 5 illustrates an example computing system.

FIG. 6 illustrates a block diagram of an example processor and/or System on a Chip (SoC) that may have one or more cores and an integrated memory controller.

FIG. 7(A) is a block diagram illustrating both an example in-order pipeline and an example register renaming, out-of-order issue/execution pipeline according to examples.

FIG. 7(B) is a block diagram illustrating both an example in-order architecture core and an example register renaming, out-of-order issue/execution architecture core to be included in a processor according to examples.

FIG. 8 illustrates examples of execution unit(s) circuitry.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

Some embodiments provide techniques to allow for co-existence (or simultaneous use) and/or inter-operation of legacy Input/Output (“IO” or “I/O”) devices and Trusted Execution Environment (TEE) capable IO devices from confidential virtual machine(s). One or more embodiments enable co-existence or simultaneous use of legacy devices and TEE-IO capable devices from one or more TEE Virtual Machines (TVMs). In an embodiment, a TVM supports two address spaces: (i) a TEE address space, and (ii) a non-TEE address space, where the TEE address space is used to map TEE-IO devices and the non-TEE address space is used to map legacy 10 devices. In another embodiment, one of a Memory Management Unit (MMU), an Input-Output MMU (IOMMU), an IO agent, and/or Peripheral Component Interconnect express (PCIe) or Compute Express Link (CXL) root port tags or manages Memory Mapped Input/Output (MMIO), Direct Memory Access (DMA), or Peer-to-Peer (P2P) transactions to support co-existence and simultaneous use of TEE-IO and legacy devices from TVMs.

Moreover, Intel Corporation's Trust Domain Extensions (Intel TDX) has introduced new, architectural elements to help deploy hardware-isolated, Virtual Machines (VMs) called Trust Domains (TDs) or TEE virtual machines (TVMs). Intel TDX is designed to isolate VMs from the virtual-machine manager (VMM)/hypervisor and any other non-TD software/entities on the platform. One or more embodiments described herein extend the TDX-IO architecture to support co-existence and inter-operation of legacy devices and TDX-IO devices from trust domains.

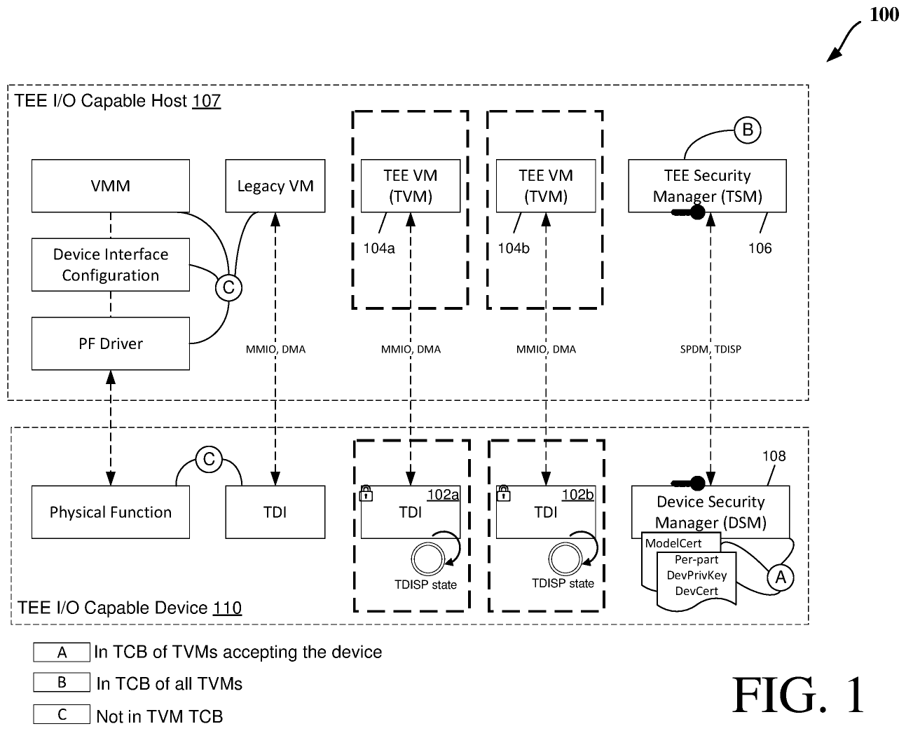

FIG. 1 illustrates a block diagram of a high-level architecture 100 for a TEE-IO framework, which may be utilized in some embodiments. Generally, TEE-IO framework defines an architecture for directly assigning TEE Device Interfaces (TDIs) 102a/102b to TEE Virtual Machines (TVMs) 104a/104b, respectively.

TEE security manager (TSM) 106 is a logical entity in a host 107 that is in the TCB for a TVM and enforces security policies on the host. The Device Security Manager (DSM) 108 is a logical entity in the device 110 that may be admitted into the TCB for a TVM by the TSM 106 and enforces security policies on the device 110.

In one or more embodiments, the DSM 108 provides one or more of the following functions:

(1) Authentication of device identities and/or measurement reporting.

(2) Configuring Integrity & Data Encryption (IDE) encryption keys in the device 110.

(3) Device interface management for locking TDI configuration, reporting TDI configurations, attaching, and/or detaching TDIs from TVMs.

(4) Implementing access control and/or security mechanisms to isolate TVM-provided data from entities not in the TCB of the TVM.

In one or more embodiments, the TSM 106 provides one or more of the following functions:

(1) Provides interface(s) to the VMM to assign memory, Central Processing Unit (CPU) or processor, and/or TDI resources to TVMs.

(2) Implements the security mechanisms and access controls (e.g., IOMMU translation tables, etc.) to protect confidentiality and/or integrity of the TVM data and execution state in the host from entities not in the TCB of the TVM.

(3) Uses the TEE Device Interface Security Protocol (TDISP) to manage the security state of the TDIs to be used by TVMs.

(4) Establishes/manages IDE encryption keys for the host, and, if needed, schedules key refreshes.

Moreover, TDI is a unit of assignment for an I/O-virtualization capable device. For example, a TDI may be an entire device, a non-I/O Virtualization (non-IOV) Function, a Single Root I/O Virtualization (SR-IOV) Virtual Function (VF), or portion of a device. The TSM uses the TDISP to manage the TDI attach and detach to a TVM. The TSM steps the TDI through the TDISP states as part of the TDI lifecycle management process such as:

(1) Locking a TDI configuration for assignment of the TDI to the TVM.

(2) Making the TDI operational if the TVM approves of the device.

(3) Detaching a previously assigned TDI from a TVM.

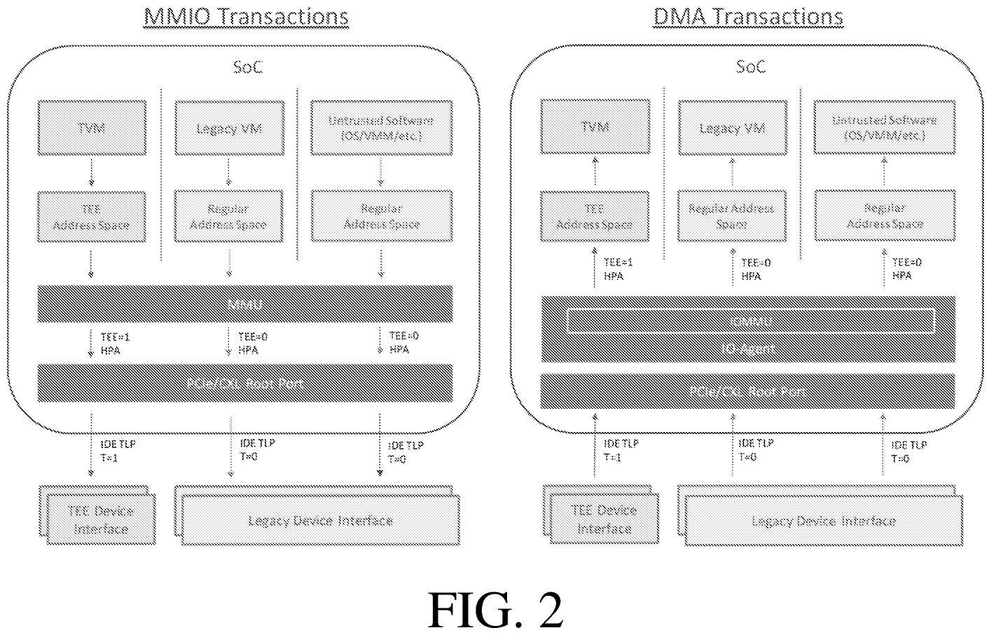

FIG. 2 illustrates high-level architectures for processing of MMIO and DMA transactions for the TEE-IO architecture of FIG. 1. As shown, MMIO transactions initiated by TVM are tagged with TEE tag of “1” (e.g., a binary 1 or “1b”) to differentiate them from the MMIO transactions initiated by a Legacy VM or a VMM (which are tagged with TEE tag of “0” (e.g., a binary 0 or “0b”)). Similarly, DMA transactions initiated by a Device Interface assigned to TVM may be tagged with TEE tag of 1b to differentiate them from the DMA transactions initiated by a Device Interface assigned to a Legacy VM or a VMM (which are tagged with TEE tag of 0b). In one embodiment, the TEE tag is conveyed through a T-bit in the PCIe/CXL IDE Transaction Layer Packet (TLP) or a TEE-bit on Intel Ultra Path Interconnect (UPI), or a TEE-bit on Intel Ultra Path CXL Interconnect (UXI) or through an IDE_T-signal on Intel On-chip System Fabric (IOSF)—Primary (IOSF-P) bus.

Such a requirement to tag TVM related transactions differently from the Legacy VM, may impose restrictions on the co-existence and/or simultaneous use of legacy devices and TEE-IO capable devices from the TVM.

To reduce any potential restrictions, one or more extensions to support co-existence and/or simultaneous use of legacy devices and TEE-IO capable devices from the TVM are disclosed in one or more embodiments.

In an embodiment, TVM supports two address spaces: (i) TEE address space, and (ii) non-TEE address space. The TEE address space may be used to map MMIO pages associated with the device interface that is going to operate on TEE (and non-TEE) data (e.g., TEE-IO capable device interface). Further, the non-TEE address space may be used to map MMIO pages associated with the device interface that is going to operate only on non-TEE data (e.g., legacy device). In one embodiment, the page tables representing the TEE address space of TVM are managed by the TSM and the page tables representing non-TEE address space of TVM are managed by the VMM.

In a first embodiment, an Address Space Type (AST) field in Guest Physical Address (GPA) is used to differentiate between TEE and non-TEE address spaces. For example, when the address space type field GPA.AST is 0b, it indicates GPA is referring to TEE address space and when the address space type field GPA.AST is 1b, it indicates GPA is referring to non-TEE address space. Also, while some embodiments may indicate that a tag “0” or a tag “1” is used to indicate a condition, embodiments are not limited to this and these values may be reversed depending on the implementation.

In a second embodiment, an AST attribute of a Host Physical Address (HPA) may be used to differentiate between TEE and non-TEE address spaces. For example, when the address space type attribute HPA.AST is 0b, it indicates HPA is referring to a non-TEE address space and when the address space type attribute HPA.AST is 1b, it indicates HPA is referring to a TEE address space. In one example, AST attribute is stored in a table entry (e.g., host permission table entry) that is referenced by an HPA or is stored in a table entry (e.g., extended/second-level page-table entry) that provides an HPA based on the address translation.

In a third embodiment, a Key Identifier (KEYID) field in an HPA may be used to differentiate between TEE and non-TEE address space. For example, when the KEYID is a TEE KEYID, it indicates HPA is referring to a TEE address space and when the KEYID is a non-TEE KEYID, it indicates HPA is referring to a non-TEE address space. In one example, a mask value is applied to the KEYID field in an HPA to make the determination if the KEYID is a TEE KEYID or a non-TEE KEYID.

In a fourth embodiment, an AST attribute of a KEYID associated with an HPA may be used to differentiate between TEE and non-TEE address space. For example, an HPA is used to index a table (e.g., Scalable Multi-Key Total Memory Encryption Table) to get the KEYID associated with HPA and then KEYID is used to locate KEYID attributes including the AST attribute (e.g., from a KEY Table). For example, when the address space type attribute KEYID.AST is 0b, it indicates HPA is referring to a non-TEE address space and when the address space type attribute KEYID.AST is 1b, it indicates HPA is referring to a TEE address space.

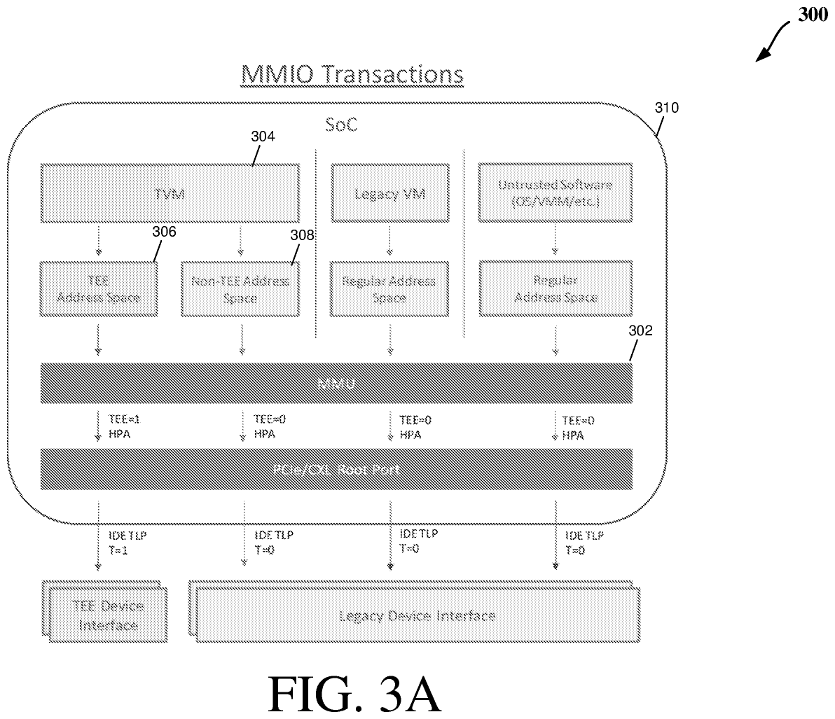

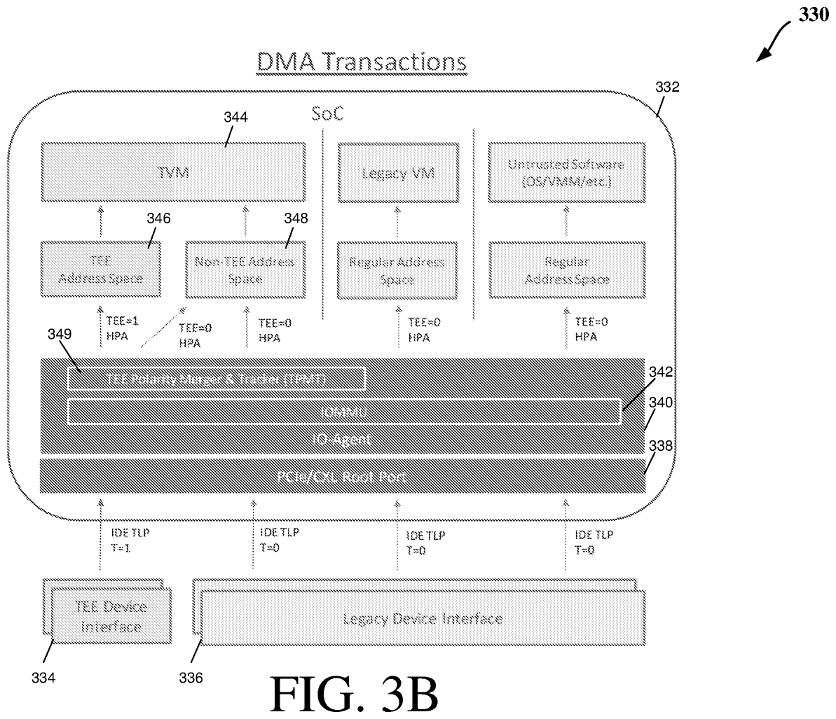

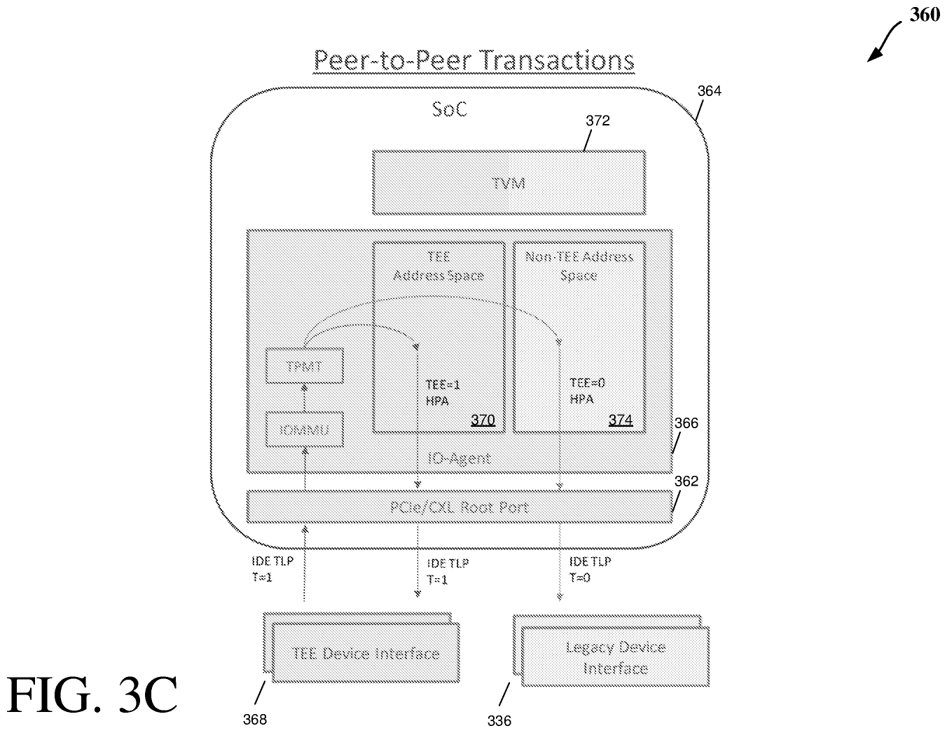

FIG. 3A illustrates a block diagram of an architecture 300 to generate TEE tags for MMIO transactions from TVMs, according to an embodiment. In one embodiment, the MMU logic circuitry 302 is configured to perform access checks and to tag MMIO transactions initiated from TVM 304 based on the address space being accessed by the TVM 304. For example, if the TVM is attempting to access the TEE address space 306, MMU logic circuitry 302 performs the access check based on the TEE page tables and tags the MMIO transaction with TEE tag of 1b. Further, if TVM 304 is attempting to access a non-TEE address space 308, the MMU logic circuitry 302 performs the access check based on the non-TEE page tables and tags the MMIO transaction with TEE tag of 0b. In at least one embodiment, all MMIO transactions generated by Legacy VM or VMM are tagged with TEE tag of 0b.

In a first embodiment, the MMU logic circuitry 302 derives the TEE tag based on the input address used to perform address translation using the page tables. For example, the GPA.AST field of the input address is used when performing address translation using the extended/second-level page tables (e.g., MMU_TEE_POLARITY=TEE_POLARITY_VM & !GPA.AST).

In a second embodiment, the MMU logic circuitry 302 derives the TEE tag based on the output address generated after performing the address translation using the page tables. For example, the HPA.AST attribute of the output address is used when performing address translation using the extended/second-level page tables (e.g., MMU_TEE_POLARITY=TEE_POLARITY_VM & HPA.AST).

In a third embodiment, the MMU logic circuitry 302 derives the TEE tag based on the KEYID field embedded inside of output address generated after performing the address translation using the page tables. For example, HPA.KEYID field of the output address is used when performing address translation using the extended/second-level page tables (e.g., MMU_TEE_POLARITY=TEE_POLARITY_VM & IS_TEE_KEYID(HPA.KEYID)).

In a fourth embodiment, the MMU logic circuitry 302 derives the TEE tag based on an attribute of a KEYID associated with the output address generated after performing the address translation using the page tables. For example, KEYID.AST attribute of the output address is used when performing address translation using the extended/second-level page tables (e.g., MMU_TEE_POLARITY=TEE_POLARITY_VM & KEYID.AST(HPA)).

In one embodiment, the MMU logic circuitry 302 may strip-off/mask the KEYID field in outbound MMIO transactions, once the TEE tag is determined.

Some embodiments introduce one or more extensions to PCIe/CXL Root Ports to use a TEE tag of MMIO transaction as a T-bit value in IDE TLP when transmitting the MMIO transaction outside of System on Chip (“SoC” which may also be interchangeably referred to herein as “SOC”) 310 (e.g., IDE_TLP.T=MMU_TEE_POLARITY).

In some embodiments, one or more extensions to internal IO fabric are introduced to use the TEE tag of a MMIO transaction as an IDE_T-signal on IOSF-P (e.g., IOSF.IDE_T=MMU_TEE_POLARITY) or as a TEE-bit on UXI or as a TEE-bit on UPI such as shown in the below Table 1.

TABLE 1

| | | |
|---|---|---|
| Device Interface | Mapped in TEE address | MMIO transactions |
| assigned to TVM | space | tagged with TEE tag 1b |
| | Mapped in non-TEE | MMIO transactions |
| | address space | tagged with TEE tag 0b |
| Device Interface | Mapped in regular address | MMIO transactions |
| assigned to | space | tagged with TEE tag 0b |
| Legacy VM or | | |
| VMM | | |

FIG. 3B illustrates a block diagram of an architecture 330 to generate a TEE tag for DMA transactions initiated from the device interfaces assigned to TVMs, according to an embodiment.

Generally, device interfaces assigned to TVMs are expected to tag all upstream DMA transactions with TEE tag of 1b. Such a tagging scheme helps the SoC 332 to differentiate the DMA transactions issued by device interfaces 334 assigned to TVMs from the DMA transaction issued by legacy device interfaces 336 assigned to Legacy VMs or VMM. However, such a requirement may become restrictive for supporting co-existence or use of TEE and non-TEE device interfaces from TVMs.

In an embodiment, an extension to PCIe/CXL Root Ports 338 is proposed that uses a T-bit value from IDE TLP as the TEE tag of an incoming DMA request from the device interface (e.g., TEE_POLARITY_DEVIF=IDE_TLP.T).

In some embodiments, an extension to the internal IO agent fabric 340 uses an IDE_T-signal on IOSF-P as TEE tag of DMA request from the device interface (e.g., TEE_POLARITY_DEVIF=IOSF.IDE_T). For example, an IOMMU logic circuitry 342 may perform access checks and tag the DMA transactions initiated from device interface 334 assigned to TVM 344 based on the address space being accessed by the device interface. For example, if a device interface assigned to TVM 344 is attempting to DMA to a TEE address space 346, the IOMMU logic circuitry 342 performs the access check based on the TEE page tables and tags the DMA transaction with TEE tag of 1b. Further, if a device interface assigned to TVM 344 is attempting to DMA to a non-TEE address space 348, the IOMMU logic circuitry 342 performs the access check based on the non-TEE page tables and tags the DMA transaction with TEE tag of 0b. In at least one embodiment, all DMA transactions generated by device interfaces assigned to Legacy VM or VMM are tagged with TEE tag of 0b.

In a first embodiment, the IOMMU logic circuitry 342 derives a TEE tag based on the input address used to perform address translation using the page tables. For example, a GPA.AST field of the input address is used when performing address translation using the extended/second-level page tables (e.g., IOMMU_TEE_POLARITY=TEE_POLARITY_DEVIF & !GPA.AST).

In a second embodiment, the IOMMU logic circuitry 342 derives a TEE tag based on the output address generated after performing the address translation using the page tables. For example, a HPA.AST attribute of the output address is used when performing address translation using the extended/second-level page tables (e.g., IOMMU_TEE_POLARITY=TEE_POLARITY_DEVIF & HPA.AST).

In a third embodiment, the IOMMU logic circuitry 342 derives a TEE tag based on a KEYID field embedded inside of output address generated after performing the address translation using the page tables. For example, a HPA.KEYID field of the output address is used when performing address translation using the extended/second-level page tables (e.g., IOMMU_TEE_POLARITY=TEE_POLARITY_DEVIF & IS_TEE_KEYID(HPA.KEYID)).

In a fourth embodiment, the IOMMU logic circuitry 342 derives a TEE tag based on an attribute of a KEYID associated with the output address generated after performing the address translation using the page tables. For example, KEYID.AST attribute of the output address is used when performing address translation using the extended/second-level page tables (e.g., IOMMU_TEE_POLARITY=TEE_POLARITY_DEVIF & KEYID.AST(HPA)).

In one embodiment, an extension to IO-agent logic circuitry 340 is provided (referred to herein as a TEE Polarity Merger & Tracker or “TPMT”) to combine the TEE tag generated by the IOMMU logic circuitry 342 with the TEE tag received from the device interface 334 assigned to TVM to generate the DMA TEE tag to be transmitted over the SoC fabric (e.g., DMA_TEE_POLARITY=TEE_POLARITY_DEVIF & IOMMU_TEE_POLARITY). For example, the IO-agent logic circuitry 340 generates the same TEE tag of 1b for the DMA as the original TEE tag received when the device interface assigned to TVM is attempting to access TEE address space 346. Further, the IO-agent logic circuitry 340 may downgrade the TEE tag to 0b for the DMA when the device interface assigned to TVM is attempting to access the non-TEE address space 348. Additionally, the IO-agent logic circuitry 340 may track/remember the original TEE tag for non-posted transactions or DMA read transactions, so the IO-agent logic circuitry 340 can re-upgrade (e.g., based on the data stored in a read tracker/TPMT 349) the TEE tag back to 1b on the completions. In some embodiments, non-posted transactions are ones where the requester expects to receive a completion Transaction Layer Packet (TLP) from the completer completing the request. In one embodiment, the non-posted transaction is a Memory Read, a Memory Read Lock, an I/O Read, an I/O Write, a Configuration Read, a Configuration Write, or an Unordered I/O(UIO) Request as defined by the PCIe/CXL specification.

In at least one embodiment, the IO-agent logic circuitry 340 may strip-off/mask KEYID field when a DMA is targeting an MMIO region, once the TEE tag is determined as shown in Table 2 below.

TABLE 2

| | | | |
|---|---|---|---|
| Device Interface | DMA target | IO-agent keeps the | DMA |
| assigned to TVM | mapped in TEE | original polarity of | transactions |
| | address space | 1b | tagged with |
| | | | TEE tag 1b |
| | DMA target | IO-agent downgrades | DMA |
| | mapped in non- | the original polarity | transactions |
| | TEE address | from 1b to 0b. | tagged with |
| | space | For non-posted | TEE tag 0b |
| | | transactions or reads, | |
| | | IO-agent re-upgrades | |
| | | the polarity back to | |
| | | 1b on completions. | |
| Device Interface | DMA target | IO-agent keeps the | DMA |
| assigned to | mapped in | original polarity of | transactions |
| Legacy VM or | regular address | 0b. | tagged with |
| VMM | space | | TEE tag 0b |

FIG. 3C illustrates a block diagram of an architecture 360 to generate a TEE tag for Peer-to-Peer (P2P) transactions initiated from the device interfaces assigned to TVMs, according to an embodiment. Generally, P2P transactions can be considered as DMA transactions targeting the MMIO address of a peer device, so one or more of the extensions described in the DMA section above with reference to FIG. 3B may also apply to the P2P transactions.

In one embodiment, PCIe/CXL Root Port 362 uses a TEE tag of DMA transaction as a T-bit value in IDE TLP when transmitting a P2P MMIO transaction outside of the SoC 364 (e.g., IDE_TLP.T=DMA_TEE_POLARITY). In some embodiments, additional extensions to the internal IO fabric 366 include the use of a TEE tag of DMA transaction as an IDE_T-signal on IOSF-P (e.g., IOSF.IDE_T=DMA_TEE_POLARITY).

As shown in FIG. 3C, P2P transactions from the device interfaces 368 assigned to TEE address space 370 of TVM 372 arrive at the SoC 364 with a TEE tag of 1b, the SoC 364 then performs the access checks and will forward the P2P transactions with an identical TEE tag of 1b if the target device interface is also mapped into TVM's TEE address space 370. Further, P2P transactions from the device interface 368 assigned to the TEE address space 370 of TVM 372 arrive at the SoC 364 with TEE tag of 1b, the SoC 364 then performs the access checks and will forward the P2P transactions with a downgraded TEE tag of 0b if the target device interface is mapped into TVM's non-TEE address space 374. For non-posted transactions or read operations, the SoC 364 may re-upgrade TEE tag from 0b to 1b on completions to ensure that the source device detects the original polarity of 1b.

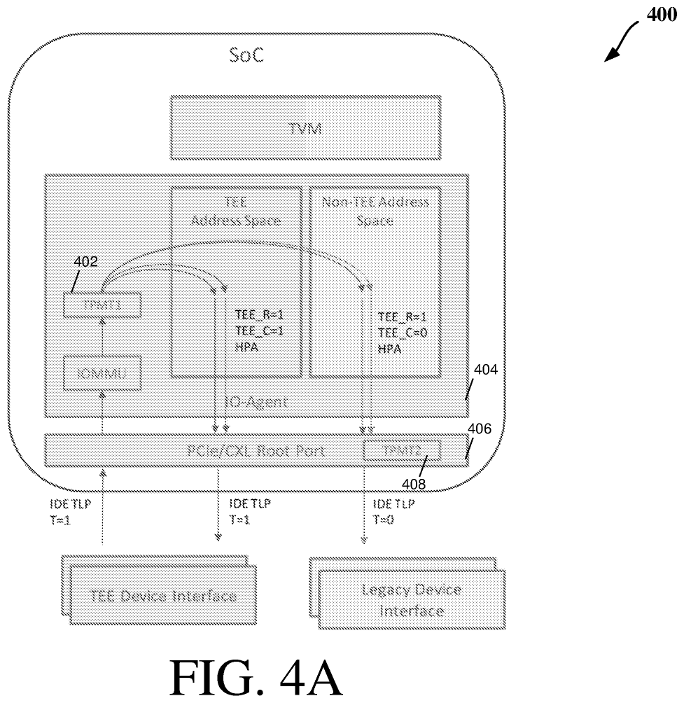

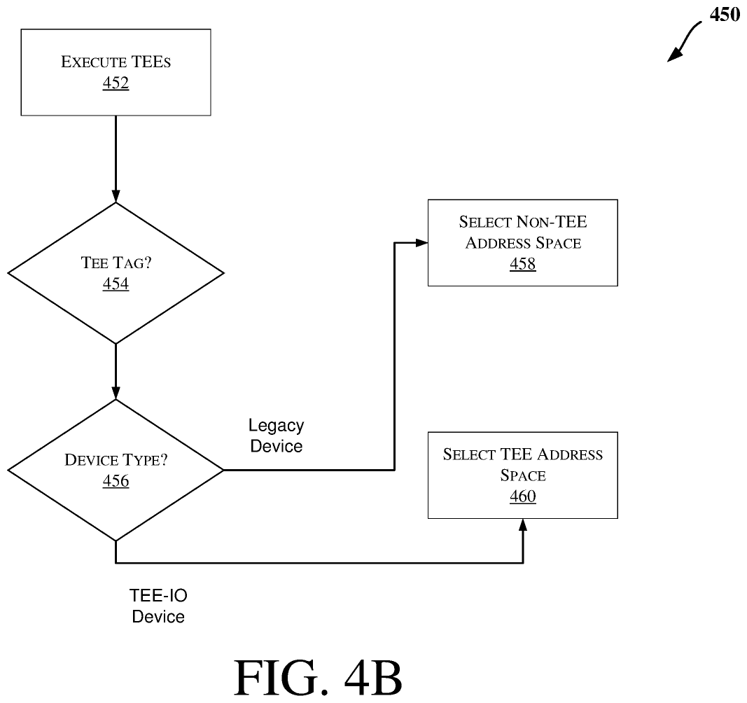

FIG. 4A illustrates a block diagram of an architecture 400 with multiple TPMTs, according to some embodiments.

In one or more embodiments discussed above (e.g., with reference to FIGS. 3A-3C), the MMU logic circuitry is responsible for converting a requester's TEE tag (e.g., a TVM's TEE tag) to a completer's TEE tag (e.g., a TEE tag of resource being accessed). Similarly, the IOMMU logic circuitry may be responsible for converting a requester's TEE tag (e.g., a TEE Device Interface's TEE tag) to the completer's TEE tag (e.g., TEE tag of resource being accessed).

In another embodiment, both the requester's and completer's TEE tag may be carried in different SoC fabrics (e.g., UPI, IOSF, UXI, etc.).

In one embodiment, the MMU and/or IOMMU logic circuitry generate two signals or bits including: (i) TEE_POLARITY_REQUESTER representing the TEE tag of the requester; and (ii) TEE_POLARITY_COMPLETER representing TEE tag of the completer. For example, the MMU logic circuitry may generate these signals as: (i) TEE_POLARITY_REQUESTER=TEE_POLARITY_VM; and (ii) TEE_POLARITY_COMPLETER=MMU_TEE_POLARITY. Further, the IOMMU logic circuitry may generate these signals as: (i) TEE_POLARITY_REQUESTER=TEE_POLARITY_DEVIF; and (ii) TEE_POLARITY_COMPLETER=IOMMU_TEE_POLARITY.

In an embodiment, the responsibilities of a TPMT (e.g., TPMT1 402) in IO-agent 404 is reduced to track the TEE tag for only memory read operations.

In one embodiment, the PCIe/CXL Root Port logic circuitry 406 may be extended to introduce a TEE Polarity Merger and Tracker (e.g., TPMT2 408) that merges the two signals and generates a TEE polarity of an MMIO transaction (e.g., TEE_POLARITY=TEE_POLARITY_REQUESTER & TEE_POLARITY_COMPLETER).

In at least one embodiment, the TPMT2 408 may track TEE_POLARITY_REQUESTER for non-posted transactions or read operations, so the TEE tag can be re-adjusted (e.g., upgraded) on completions.

Furthermore, as a move towards disaggregated compute/IO die architecture and/or support for PCIe Gen6 is made, it may not be viable to build a tracking structure in the IO-agents. Extending SoC fabrics to carry two signals would allow some embodiments to distribute the functionality (e.g., TPMT1 in IO-agent and TPMT2 in PCIe/CXL Root Port). For example, the PCIe/CXL Root Port may track information about pending non-posted transactions or read operations to support timeouts and other conditions; hence, adding a TEE tag attribute in such a structure may simplify the hardware implementation.

FIG. 4B illustrates a flow diagram of a method 450 to enable co-existence and inter-operation of legacy devices and TEE-IO capable devices, according to an embodiment.

Referring to FIGS. 1-4B, at an operation 452, a processor executes one or more Trusted Execution Environments (TEEs) with a TEE address space and a non-TEE address space. At an operation 454, if a TEE tag is present with a transaction, operation 456 determines what type of device is present, a legacy device or a TEE-IO device. For a legacy device, operation 458 uses a non-TEE address space. For a TEE-IO device, operation 460 utilizes a TEE address space.

In an embodiment, logic circuitry selects between the TEE address space and the non-TEE address space based at least in part on the value of the TEE tag for the transaction. The TEE address space maps one or more TEE Input/Output (TO) devices and the non-TEE address space maps one or more legacy IO devices. The TEE tag may be generated based at least in part on a value of a field in an address of the transaction. The field is one of: an Address Space Type (AST) field in a Guest Physical Address (GPA) and a Key Identifier (KEYID) field in a Host Physical Address (HPA). The TEE tag may also be generated based at least in part on a value of an attribute for an address of the transaction. The attribute may be one of: an Address Space Type (AST) attribute of a Host Physical Address (HPA), and an AST attribute of a KEYID associated with an HPA.

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

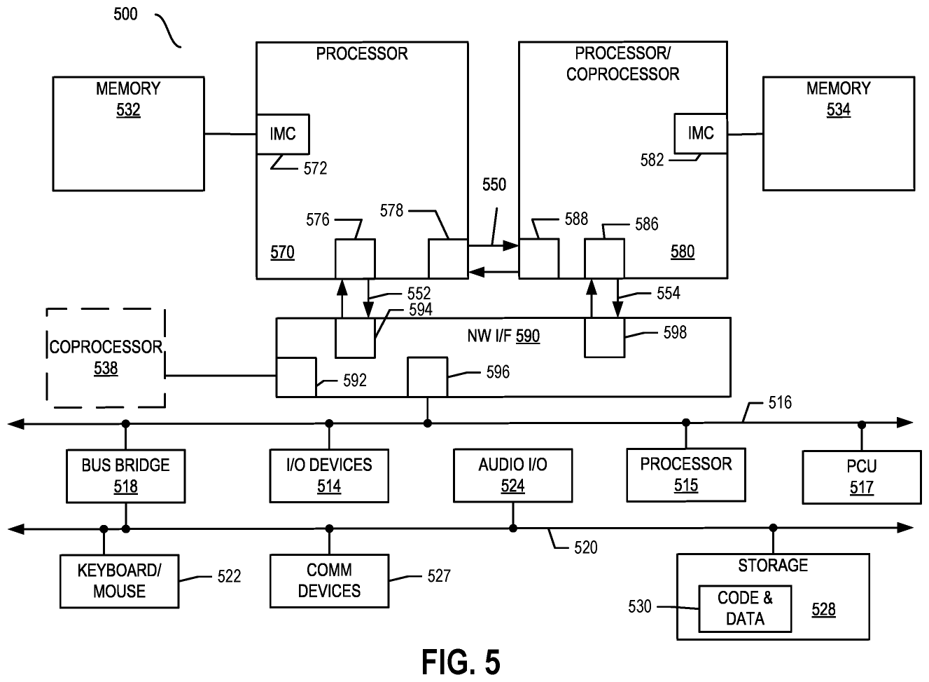

FIG. 5 illustrates an example computing system. Multiprocessor system 500 is an interfaced system and includes a plurality of processors or cores including a first processor 570 and a second processor 580 coupled via an interface 550 such as a point-to-point (P-P) interconnect, a fabric, and/or bus. In some examples, the first processor 570 and the second processor 580 are homogeneous. In some examples, first processor 570 and the second processor 580 are heterogenous. Though the example system 500 is shown to have two processors, the system may have three or more processors, or may be a single processor system. In some examples, the computing system is a system on a chip (SoC).

Processors 570 and 580 are shown including integrated memory controller (IMC) circuitry 572 and 582, respectively. Processor 570 also includes interface circuits 576 and 578; similarly, second processor 580 includes interface circuits 586 and 588. Processors 570, 580 may exchange information via the interface 550 using interface circuits 578, 588. IMCs 572 and 582 couple the processors 570, 580 to respective memories, namely a memory 532 and a memory 534, which may be portions of main memory locally attached to the respective processors.

Processors 570, 580 may each exchange information with a network interface (NW I/F) 590 via individual interfaces 552, 554 using interface circuits 576, 594, 586, 598. The network interface 590 (e.g., one or more of an interconnect, bus, and/or fabric, and in some examples is a chipset) may optionally exchange information with a coprocessor 538 via an interface circuit 592. In some examples, the coprocessor 538 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 570, 580 or outside of both processors, yet connected with the processors via an interface such as P-P interconnect, such that either or both processors' local cache information may be stored in the shared cache if a processor is placed into a low power mode.

Network interface 590 may be coupled to a first interface 516 via interface circuit 596. In some examples, first interface 516 may be an interface such as a Peripheral Component Interconnect (PCI) interconnect, a PCI Express interconnect or another I/O interconnect. In some examples, first interface 516 is coupled to a power control unit (PCU) 517, which may include circuitry, software, and/or firmware to perform power management operations with regard to the processors 570, 580 and/or co-processor 538. PCU 517 provides control information to a voltage regulator (not shown) to cause the voltage regulator to generate the appropriate regulated voltage. PCU 517 also provides control information to control the operating voltage generated. In various examples, PCU 517 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 517 is illustrated as being present as logic separate from the processor 570 and/or processor 580. In other cases, PCU 517 may execute on a given one or more of cores (not shown) of processor 570 or 580. In some cases, PCU 517 may be implemented as a microcontroller (dedicated or general-purpose) or other control logic configured to execute its own dedicated power management code, sometimes referred to as P-code. In yet other examples, power management operations to be performed by PCU 517 may be implemented externally to a processor, such as by way of a separate power management integrated circuit (PMIC) or another component external to the processor. In yet other examples, power management operations to be performed by PCU 517 may be implemented within BIOS or other system software.

Various I/O devices 514 may be coupled to first interface 516, along with a bus bridge 518 which couples first interface 516 to a second interface 520. In some examples, one or more additional processor(s) 515, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 516. In some examples, second interface 520 may be a low pin count (LPC) interface. Various devices may be coupled to second interface 520 including, for example, a keyboard and/or mouse 522, communication devices 527 and storage circuitry 528. Storage circuitry 528 may be one or more non-transitory machine-readable storage media as described below, such as a disk drive or other mass storage device which may include instructions/code and data 530 and may implement the storage 'ISAB03 in some examples. Further, an audio I/O 524 may be coupled to second interface 520. Note that other architectures than the point-to-point architecture described above are possible. For example, instead of the point-to-point architecture, a system such as multiprocessor system 500 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

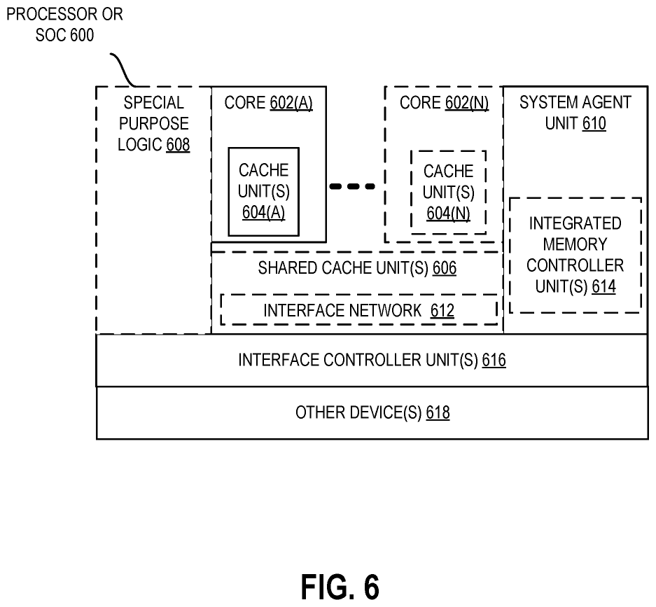

FIG. 6 illustrates a block diagram of an example processor and/or SoC 600 that may have one or more cores and an integrated memory controller. The solid lined boxes illustrate a processor 600 with a single core 602(A), system agent unit circuitry 610, and a set of one or more interface controller unit(s) circuitry 616, while the optional addition of the dashed lined boxes illustrates an alternative processor 600 with multiple cores 602(A)-(N), a set of one or more integrated memory controller unit(s) circuitry 614 in the system agent unit circuitry 610, and special purpose logic 608, as well as a set of one or more interface controller units circuitry 616. Note that the processor 600 may be one of the processors 570 or 580, or co-processor 538 or 515 of FIG. 5.

Thus, different implementations of the processor 600 may include: 1) a CPU with the special purpose logic 608 being integrated graphics and/or scientific (throughput) logic (which may include one or more cores, not shown), and the cores 602(A)-(N) being one or more general purpose cores (e.g., general purpose in-order cores, general purpose out-of-order cores, or a combination of the two); 2) a coprocessor with the cores 602(A)-(N) being a large number of special purpose cores intended primarily for graphics and/or scientific (throughput); and 3) a coprocessor with the cores 602(A)-(N) being a large number of general purpose in-order cores. Thus, the processor 600 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 604(A)-(N) within the cores 602(A)-(N), a set of one or more shared cache unit(s) circuitry 606, and external memory (not shown) coupled to the set of integrated memory controller unit(s) circuitry 614. The set of one or more shared cache unit(s) circuitry 606 may include one or more mid-level caches, such as level 2 (L2), level 3 (L3), level 4 (L4), or other levels of cache, such as a last level cache (LLC), and/or combinations thereof. While in some examples interface network circuitry 612 (e.g., a ring interconnect) interfaces the special purpose logic 608 (e.g., integrated graphics logic), the set of shared cache unit(s) circuitry 606, and the system agent unit circuitry 610, alternative examples use any number of well-known techniques for interfacing such units. In some examples, coherency is maintained between one or more of the shared cache unit(s) circuitry 606 and cores 602(A)-(N). In some examples, interface controller units circuitry 616 couple the cores 602 to one or more other devices 618 such as one or more I/O devices, storage, one or more communication devices (e.g., wireless networking, wired networking, etc.), etc.

In some examples, one or more of the cores 602(A)-(N) are capable of multi-threading. The system agent unit circuitry 610 includes those components coordinating and operating cores 602(A)-(N). The system agent unit circuitry 610 may include, for example, power control unit (PCU) circuitry and/or display unit circuitry (not shown). The PCU may be or may include logic and components needed for regulating the power state of the cores 602(A)-(N) and/or the special purpose logic 608 (e.g., integrated graphics logic). The display unit circuitry is for driving one or more externally connected displays.

The cores 602(A)-(N) may be homogenous in terms of instruction set architecture (ISA). Alternatively, the cores 602(A)-(N) may be heterogeneous in terms of ISA; that is, a subset of the cores 602(A)-(N) may be capable of executing an ISA, while other cores may be capable of executing only a subset of that ISA or another ISA.

Example Core Architectures—In-Order and Out-of-Order Core Block Diagram

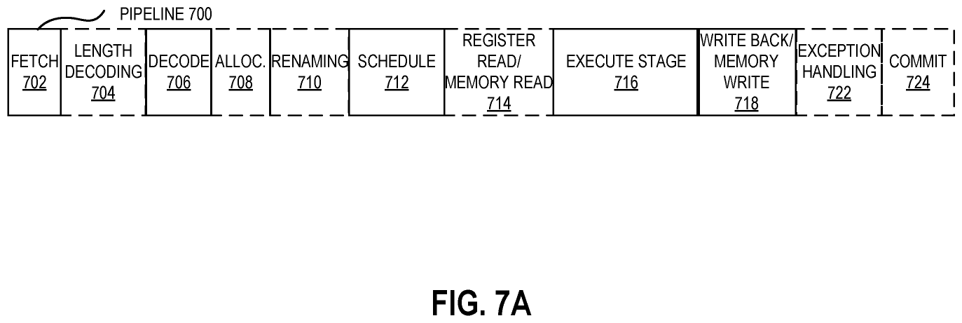

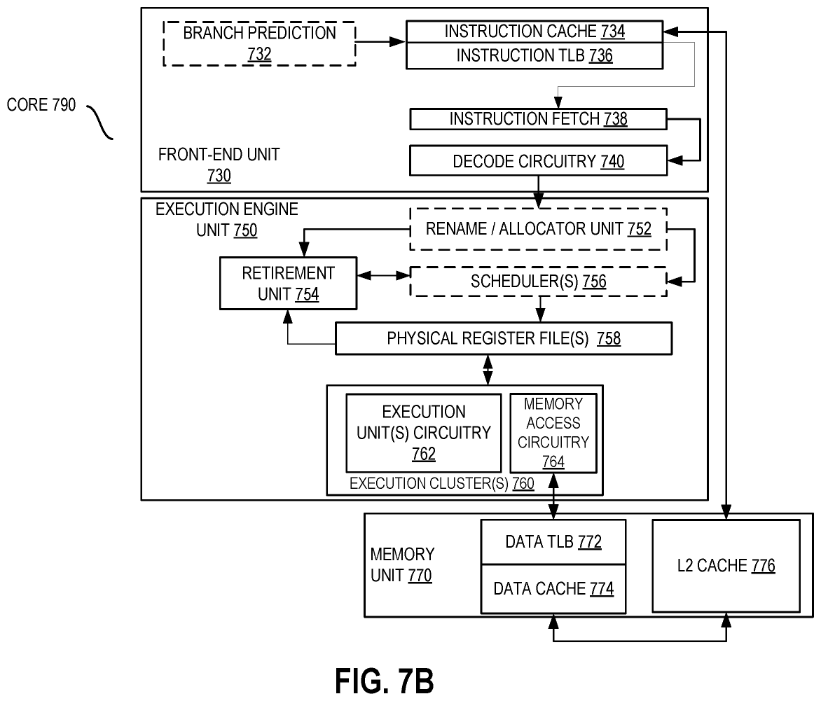

FIG. 7(A) is a block diagram illustrating both an example in-order pipeline and an example register renaming, out-of-order issue/execution pipeline according to examples. FIG. 7(B) is a block diagram illustrating both an example in-order architecture core and an example register renaming, out-of-order issue/execution architecture core to be included in a processor according to examples. The solid lined boxes in FIGS. 7(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7(A), a processor pipeline 700 includes a fetch stage 702, an optional length decoding stage 704, a decode stage 706, an optional allocation (Alloc) stage 708, an optional renaming stage 710, a schedule (also known as a dispatch or issue) stage 712, an optional register read/memory read stage 714, an execute stage 716, a write back/memory write stage 718, an optional exception handling stage 722, and an optional commit stage 724. One or more operations can be performed in each of these processor pipeline stages. For example, during the fetch stage 702, one or more instructions are fetched from instruction memory, and during the decode stage 706, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 706 and the register read/memory read stage 714 may be combined into one pipeline stage. In one example, during the execute stage 716, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 7(B) may implement the pipeline 700 as follows: 1) the instruction fetch circuitry 738 performs the fetch and length decoding stages 702 and 704; 2) the decode circuitry 740 performs the decode stage 706; 3) the rename/allocator unit circuitry 752 performs the allocation stage 708 and renaming stage 710; 4) the scheduler(s) circuitry 756 performs the schedule stage 712; 5) the physical register file(s) circuitry 758 and the memory unit circuitry 770 perform the register read/memory read stage 714; the execution cluster(s) 760 perform the execute stage 716; 6) the memory unit circuitry 770 and the physical register file(s) circuitry 758 perform the write back/memory write stage 718; 7) various circuitry may be involved in the exception handling stage 722; and 8) the retirement unit circuitry 754 and the physical register file(s) circuitry 758 perform the commit stage 724.

FIG. 7(B) shows a processor core 790 including front-end unit circuitry 730 coupled to execution engine unit circuitry 750, and both are coupled to memory unit circuitry 770. The core 790 may be a reduced instruction set architecture computing (RISC) core, a complex instruction set architecture computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front-end unit circuitry 730 may include branch prediction circuitry 732 coupled to instruction cache circuitry 734, which is coupled to an instruction translation lookaside buffer (TLB) 736, which is coupled to instruction fetch circuitry 738, which is coupled to decode circuitry 740. In one example, the instruction cache circuitry 734 is included in the memory unit circuitry 770 rather than the front-end circuitry 730. The decode circuitry 740 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 740 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 740 may be implemented using various different mechanisms. Examples of suitable mechanisms include, but are not limited to, look-up tables, hardware implementations, programmable logic arrays (PLAs), microcode read only memories (ROMs), etc. In one example, the core 790 includes a microcode ROM (not shown) or other medium that stores microcode for certain macroinstructions (e.g., in decode circuitry 740 or otherwise within the front-end circuitry 730). In one example, the decode circuitry 740 includes a micro-operation (micro-op) or operation cache (not shown) to hold/cache decoded operations, micro-tags, or micro-operations generated during the decode or other stages of the processor pipeline 700. The decode circuitry 740 may be coupled to rename/allocator unit circuitry 752 in the execution engine circuitry 750.

The execution engine circuitry 750 includes the rename/allocator unit circuitry 752 coupled to retirement unit circuitry 754 and a set of one or more scheduler(s) circuitry 756. The scheduler(s) circuitry 756 represents any number of different schedulers, including reservations stations, central instruction window, etc. In some examples, the scheduler(s) circuitry 756 can include arithmetic logic unit (ALU) scheduler/scheduling circuitry, ALU queues, address generation unit (AGU) scheduler/scheduling circuitry, AGU queues, etc. The scheduler(s) circuitry 756 is coupled to the physical register file(s) circuitry 758. Each of the physical register file(s) circuitry 758 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 758 includes vector registers unit circuitry, writemask registers unit circuitry, and scalar register unit circuitry. These register units may provide architectural vector registers, vector mask registers, general-purpose registers, etc. The physical register file(s) circuitry 758 is coupled to the retirement unit circuitry 754 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 754 and the physical register file(s) circuitry 758 are coupled to the execution cluster(s) 760. The execution cluster(s) 760 includes a set of one or more execution unit(s) circuitry 762 and a set of one or more memory access circuitry 764. The execution unit(s) circuitry 762 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 756, physical register file(s) circuitry 758, and execution cluster(s) 760 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 764). It should also be understood that where separate pipelines are used, one or more of these pipelines may be out-of-order issue/execution and the rest in-order.

In some examples, the execution engine unit circuitry 750 may perform load store unit (LSU) address/data pipelining to an Advanced Microcontroller Bus (AMB) interface (not shown), and address phase and writeback, data phase load, store, and branches.

The set of memory access circuitry 764 is coupled to the memory unit circuitry 770, which includes data TLB circuitry 772 coupled to data cache circuitry 774 coupled to level 2 (L2) cache circuitry 776. In one example, the memory access circuitry 764 may include load unit circuitry, store address unit circuitry, and store data unit circuitry, each of which is coupled to the data TLB circuitry 772 in the memory unit circuitry 770. The instruction cache circuitry 734 is further coupled to the level 2 (L2) cache circuitry 776 in the memory unit circuitry 770. In one example, the instruction cache 734 and the data cache 774 are combined into a single instruction and data cache (not shown) in L2 cache circuitry 776, level 3 (L3) cache circuitry (not shown), and/or main memory. The L2 cache circuitry 776 is coupled to one or more other levels of cache and eventually to a main memory.

The core 790 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 790 includes logic to support a packed data instruction set architecture extension (e.g., AVX1, AVX2), thereby allowing the operations used by many multimedia applications to be performed using packed data.

### Example Execution Unit(s) Circuitry

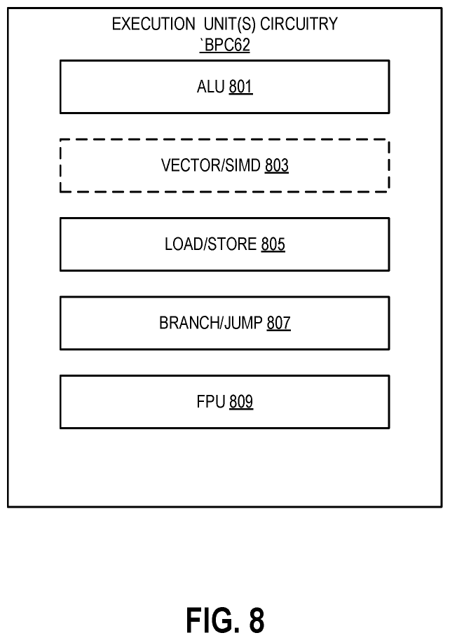

FIG. 8 illustrates examples of execution unit(s) circuitry, such as execution unit(s) circuitry 762 of FIG. 7(B). As illustrated, execution unit(s) circuitry 762 may include one or more ALU circuits 801, optional vector/single instruction multiple data (SIMD) circuits 803, load/store circuits 805, branch/jump circuits 807, and/or Floating-point unit (FPU) circuits 809. ALU circuits 801 perform integer arithmetic and/or Boolean operations. Vector/SIMD circuits 803 perform vector/SIMD operations on packed data (such as SIMD/vector registers). Load/store circuits 805 execute load and store instructions to load data from memory into registers or store from registers to memory. Load/store circuits 805 may also generate addresses. Branch/jump circuits 807 cause a branch or jump to a memory address depending on the instruction. FPU circuits 809 perform floating-point arithmetic. The width of the execution unit(s) circuitry 762 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

In this description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes An apparatus comprising: a processor to execute at least one Trusted Environment (TE) with a TE address space and a non-TE address space; and selection circuitry to select between the TE address space and the non-TE address space based at least in part on a value of a TE tag for a transaction, wherein the TE address space is to map one or more TE Input/Output (IO) devices and the non-TE address space is to map one or more legacy IO devices. Example 2 includes the apparatus of example 1, wherein the at least one TE comprises a Trusted Execution Environment (TEE), the TE address space comprises a TEE address space, and the non-TE address space comprises a non-TEE address space. Example 3 includes the apparatus of example 1, wherein the TE tag is to be generated based at least in part on a value of a field in an address of the transaction.

Example 4 includes the apparatus of example 2, wherein the field is one of: an Address Space Type (AST) field in a Guest Physical Address (GPA) and a Key Identifier (KEYID) field in a Host Physical Address (HPA). Example 5 includes the apparatus of example 1, wherein the TE tag is to be generated based at least in part on a value of an attribute for an address of the transaction. Example 6 includes the apparatus of example 4, wherein the attribute is one of: an Address Space Type (AST) attribute of a Host Physical Address (HPA), and an AST attribute of a KEYID associated with an HPA. Example 7 includes the apparatus of example 1, wherein a TEE Virtual Machine (TVM) is to generate the transaction. Example 8 includes the apparatus of example 1, wherein a TEE Device Interface (TDI) is to generate the transaction. Example 9 includes the apparatus of example 1, wherein the value of the TE tag is to be generated by one of: a Memory Management Unit (MMU), an Input-Output MMU (IOMMU), an IO agent, a Peripheral Component Interconnect express (PCIe) circuit, and a Compute Express Link (CXL) root port. Example 10 includes the apparatus of example 1, wherein the transaction is one of: a Memory Mapped Input/Output (MMIO) transaction, a Direct Memory Access (DMA) transaction, and a Peer-to-Peer (P2P) transaction.

Example 11 includes the apparatus of example 1, comprising tracking circuitry to track the value of the TE tag for non-posted transactions. Example 12 includes the apparatus of example 10, wherein the value of the TE tag is to be modified in response to completion of the non-posted transaction. Example 13 includes the apparatus of example 1, comprising generating circuitry to generate a first bit to represent a TE tag for a requester and a second bit to represent a TE tag for a completer. Example 14. One or more non-transitory computer-readable media comprising one or more instructions that when executed on a processor configure the processor to perform one or more operations to: execute at least one Trusted Environment (TE) with a TE address space and a non-TE address space; and cause logic circuitry to select between the TE address space and the non-TE address space based at least in part on a value of a TE tag for a transaction, wherein the TE address space is to map one or more TE Input/Output (TO) devices and the non-TE address space is to map one or more legacy IO devices.

Example 15 includes the one or more computer-readable media of example 14, further comprising one or more instructions that when executed on the processor configure the processor to perform one or more operations to cause the TE tag to be generated based at least in part on a value of a field in an address of the transaction. Example 16 includes the one or more computer-readable media of example 15, wherein the field is one of: an Address Space Type (AST) field in a Guest Physical Address (GPA) and a Key Identifier (KEYID) field in a Host Physical Address (HPA). Example 17 includes the one or more computer-readable media of example 14, further comprising one or more instructions that when executed on the processor configure the processor to perform one or more operations to cause the TE tag to be generated based at least in part on a value of an attribute for an address of the transaction.

Example 18 includes the one or more computer-readable media of example 17, wherein the attribute is one of: an Address Space Type (AST) attribute of a Host Physical Address (HPA), and an AST attribute of a KEYID associated with an HPA. Example 19 includes the one or more computer-readable media of example 14, further comprising one or more instructions that when executed on the processor configure the processor to perform one or more operations to cause a TEE Virtual Machine (TVM) to generate the transaction. Example 20 includes the one or more computer-readable media of example 14, further comprising one or more instructions that when executed on the processor configure the processor to perform one or more operations to cause a TEE Device Interface (TDI) to generate the transaction.

Example 21 includes A method comprising: executing, at a processor, at least one Trusted Environment (TE) with a TE address space and a non-TE address space; and selecting between the TE address space and the non-TE address space based at least in part on a value of a TE tag for a transaction, wherein the TE address space maps one or more TE Input/Output (TO) devices and the non-TE address space maps one or more legacy IO devices. Example 22 includes the method of example 21, further comprising generating the TE tag based at least in part on a value of a field in an address of the transaction. Example 23 includes the method of example 22, wherein the field is one of: an Address Space Type (AST) field in a Guest Physical Address (GPA) and a Key Identifier (KEYID) field in a Host Physical Address (HPA). Example 24 includes the method of example 21, further comprising generating the TE tag based at least in part on a value of an attribute for an address of the transaction. Example 25 includes the method of example 24, wherein the attribute is one of: an Address Space Type (AST) attribute of a Host Physical Address (HPA), and an AST attribute of a KEYID associated with an HPA.

Example 26 includes an apparatus comprising means to perform a method as set forth in any preceding example. Example 27 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In some embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a processor to execute at least one Trusted Environment (TE) with a TE address space and a non-TE address space; and
selection circuitry to select between the TE address space and the non-TE address space based at least in part on a value of a TE tag for a transaction,
wherein the TE address space is to map one or more TE Input/Output (IO) devices and the non-TE address space is to map one or more legacy IO devices.

2. The apparatus of claim 1, wherein the at least one TE comprises a Trusted Execution Environment (TEE), the TE address space comprises a TEE address space, and the non-TE address space comprises a non-TEE address space.

3. The apparatus of claim 1, wherein the TE tag is to be generated based at least in part on a value of a field in an address of the transaction.

4. The apparatus of claim 3, wherein the field is one of: an Address Space Type (AST) field in a Guest Physical Address (GPA) and a Key Identifier (KEYID) field in a Host Physical Address (HPA).

5. The apparatus of claim 1, wherein the TE tag is to be generated based at least in part on a value of an attribute for an address of the transaction.

6. The apparatus of claim 5, wherein the attribute is one of: an Address Space Type (AST) attribute of a Host Physical Address (HPA), and an AST attribute of a KEYID associated with an HPA.

7. The apparatus of claim 1, wherein a TEE Virtual Machine (TVM) is to generate the transaction.

8. The apparatus of claim 1, wherein a TEE Device Interface (TDI) is to generate the transaction.

9. The apparatus of claim 1, wherein the value of the TE tag is to be generated by one of: a Memory Management Unit (MMU), an Input-Output MMU (IOMMU), an IO agent, a Peripheral Component Interconnect express (PCIe) circuit, and a Compute Express Link (CXL) root port.

10. The apparatus of claim 1, wherein the transaction is one of: a Memory Mapped Input/Output (MMIO) transaction, a Direct Memory Access (DMA) transaction, and a Peer-to-Peer (P2P) transaction.

11. The apparatus of claim 1, comprising tracking circuitry to track the value of the TE tag for non-posted transactions.

12. The apparatus of claim 11, wherein the value of the TE tag is to be modified in response to completion of the non-posted transaction.

13. The apparatus of claim 1, comprising generating circuitry to generate a first bit to represent a TE tag for a requester and a second bit to represent a TE tag for a completer.

14. One or more non-transitory computer-readable media comprising one or more instructions that when executed on a processor configure the processor to perform one or more operations to:
execute at least one Trusted Environment (TE) with a TE address space and a non-TE address space; and
cause logic circuitry to select between the TE address space and the non-TE address space based at least in part on a value of a TE tag for a transaction,
wherein the TE address space is to map one or more TE Input/Output (IO) devices and the non-TE address space is to map one or more legacy IO devices.

15. The one or more computer-readable media of claim 14, further comprising one or more instructions that when executed on the processor configure the processor to perform one or more operations to cause the TE tag to be generated based at least in part on a value of a field in an address of the transaction.

16. The one or more computer-readable media of claim 15, wherein the field is one of: an Address Space Type (AST) field in a Guest Physical Address (GPA) and a Key Identifier (KEYID) field in a Host Physical Address (HPA).

17. The one or more computer-readable media of claim 14, further comprising one or more instructions that when executed on the processor configure the processor to perform one or more operations to cause the TE tag to be generated based at least in part on a value of an attribute for an address of the transaction.

18. The one or more computer-readable media of claim 17, wherein the attribute is one of: an Address Space Type (AST) attribute of a Host Physical Address (HPA), and an AST attribute of a KEYID associated with an HPA.

19. The one or more computer-readable media of claim 14, further comprising one or more instructions that when executed on the processor configure the processor to perform one or more operations to cause a TEE Virtual Machine (TVM) to generate the transaction.

20. The one or more computer-readable media of claim 14, further comprising one or more instructions that when executed on the processor configure the processor to perform one or more operations to cause a TEE Device Interface (TDI) to generate the transaction.

21. A method comprising:
executing, at a processor, at least one Trusted Environment (TE) with a TE address space and a non-TE address space; and
selecting between the TE address space and the non-TE address space based at least in part on a value of a TE tag for a transaction,
wherein the TE address space maps one or more TE Input/Output (TO) devices and the non-TE address space maps one or more legacy IO devices.

22. The method of claim 21, further comprising generating the TE tag based at least in part on a value of a field in an address of the transaction.

23. The method of claim 22, wherein the field is one of: an Address Space Type (AST) field in a Guest Physical Address (GPA) and a Key Identifier (KEYID) field in a Host Physical Address (HPA).

24. The method of claim 21, further comprising generating the TE tag based at least in part on a value of an attribute for an address of the transaction.

25. The method of claim 24, wherein the attribute is one of: an Address Space Type (AST) attribute of a Host Physical Address (HPA), and an AST attribute of a KEYID associated with an HPA.
